(19) United States
(12) Patent Application Publication
(10) Pub. No.: US 2016/0133889 A1
(43) Pub. Date: May 12, 2016

(54) BATTERY HOLDER

(71) Applicant: Cheng Uei Precision Industry Co., Ltd., New Taipei City (TW)

(72) Inventors: Chi Ming Tseng, New Taipei City (TW); Chin Chung Lin, New Taipei City (TW)

(21) Appl. No.: 14/535,588

(22) Filed: Nov. 7, 2014

(51) Int. Cl. H01M 2/10; H01M 10/42

(52) U.S. Cl. CPC H01M 2/1016; H01M 2/1022; H01M 2/1072; H01M 10/425

(57) ABSTRACT

A battery holder includes upper half housing, elastic slices, PCB, guide lines and lower half housing. The upper half housing has a front wall, a rear wall, a bottom wall and two side walls which together form a receiving cavity for receiving a battery. The front wall, the rear wall and the side walls of the upper half housing define a plurality of buckling slots. The PCB is positioned in the front of the upper half housing. The elastic slices are inserted in the side walls and electrically connected with the PCB through the guide lines. Inner faces of the lower half housing protrude inward to form a plurality of wedge-shaped lumps. The upper half housing is placed in the lower half housing. The wedge-shaped lumps of the lower half housing are respectively buckled in the buckling slots of the upper half housing.

### BACKGROUND OF THE INVENTION

1. Field of the Invention

The present invention relates to a battery holder with convenient assembly and low cost.

2. The Related Art

Nowadays, battery is widely used in our daily life for providing electric energy. Generally, the battery is received in a battery holder. The battery holder includes an upper half housing, a plurality of electrical slices and a lower half housing. The electrical slices are mounted in the upper half housing or the lower half housing for electrically connecting with the battery. The lower half housing sheathes outside of the upper half housing.

However, the battery holder often makes use of the ultrasonic to weld the lower half housing and the upper half housing together. This process needs a lot of Ultrasonic welding machines. It results in high cost and is inconvenient for assembly.

### SUMMARY OF THE INVENTION

Accordingly, an object of the present invention is to provide a battery holder for receiving a battery therein. The battery holder includes an upper half housing, a plurality of elastic slices, a PCB, a plurality of guide lines and a lower half housing. The upper half housing has a front wall, a rear wall, a bottom wall and two side walls which together form a receiving cavity for receiving the battery. Two sides of a front face of the front wall protrude forward and then inward to form a pair of L-shaped positioning supports. The positioning supports are vis-a-vis each other to define a receiving area therebetween. Two outer corners of the positioning supports protrude downward to form a pair of upper hooks. Two inner sides of the side walls are concaved inward and then penetrate vertically through the bottom wall to form a plurality of installing grooves. The front wall, the rear wall and the side walls of the upper half housing define a plurality of buckling slots. The elastic slices are inserted upward in the installing grooves of the side walls of the upper half housing, and the elastic slices are exposed in the receiving cavity to electrically contact with the battery. The PCB is positioned in the receiving area of the upper half housing. The guide lines are mounted to a bottom face of the bottom wall of the upper half housing. The elastic slices are electrically connected with the PCB through the guide lines. The lower half housing has a front plate, a rear plate, a bottom plate and two side plates which together form a receiving chamber. A rear face of a center of the front plate is concaved frontward to form a holding groove. Two sidewalls of the holding groove protrude inward to form a pair of lower hooks corresponding to the upper hooks of the upper half housing. An inner side of the rear plate protrudes frontward and upward to from a plurality of locking strips. A plurality of locking slots is defined between the rear plate and top ends of the locking strips. Inner faces of the front plate, the rear plate and the side plates protrude inward to form a plurality of wedge-shaped lumps corresponding to the buckling slots of the upper half housing. The upper half housing is placed in the receiving chamber of the lower half housing. The positioning supports together with the PCB are received in the holding groove of the front plate of the lower half housing. The upper hooks of the upper half housing and the lower hooks of the lower half housing are hooked together. A bottom end of the rear wall of the upper half housing is buckled in the locking slots of the rear plate of the lower half housing. The wedge-shaped lumps of the lower half housing are respectively buckled in the buckling slots of the upper half housing.

As described above, the front wall, the rear wall and the side walls of the upper half housing define the buckling slots. The inner faces of the front plate, the rear plate and the side plates protrude inward to form the wedge-shaped lumps corresponding to the buckling slots of the upper half housing. The wedge-shaped lumps of the lower half housing are respectively buckled in the buckling slots of the upper half housing so that is convenient for assembly of the battery holder and reduces cost of the battery holder.

### BRIEF DESCRIPTION OF THE DRAWINGS

The present invention will be apparent to those skilled in the art by reading the following description thereof, with reference to the attached drawings, in which:

FIG. 1 is an assembled, perspective view of a battery holder in accordance with an embodiment of the present invention;

FIG. 2 is an exploded, perspective view of the battery holder shown in FIG. 1;

FIG. 3 is a perspective view of an upper half housing of the battery holder shown in FIG. 2;

FIG. 4 is a perspective view of a lower half housing of the battery holder shown in FIG. 2;

FIG. 5 is a cross-sectional view of the battery holder along a line A of FIG. 1;

FIG. 6 is a partial enlarged drawing of an upper hook and a lower hook of the battery holder of FIG. 5;

FIG. 7 is a cross-sectional view of the battery holder along a line B of FIG. 1; and

FIG. 8 is a cross-sectional view of the battery holder along a line C of FIG. 1.

### DETAILED DESCRIPTION OF THE EMBODIMENT

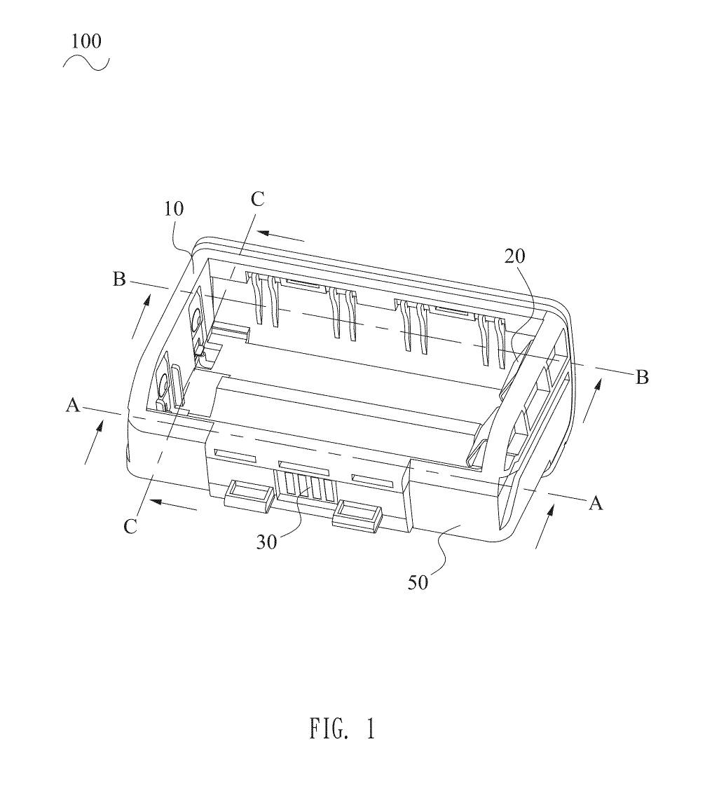

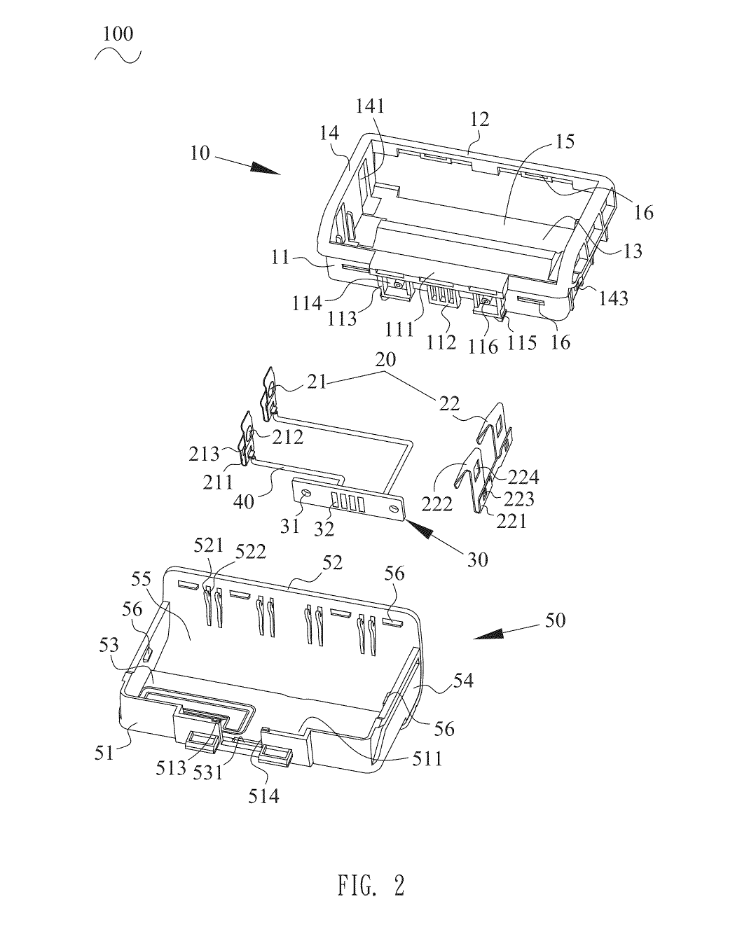

Referring to the drawings in greater detail, and first to FIG. 1 and FIG. 2, an embodiment of the present invention is embodied in a battery holder 100 for receiving a battery (not shown) therein. The battery holder 100 includes an upper half housing 10, a plurality of elastic slices 20, a PCB (printed circuit board) 30, a plurality of guide lines 40 and a lower half housing 50.

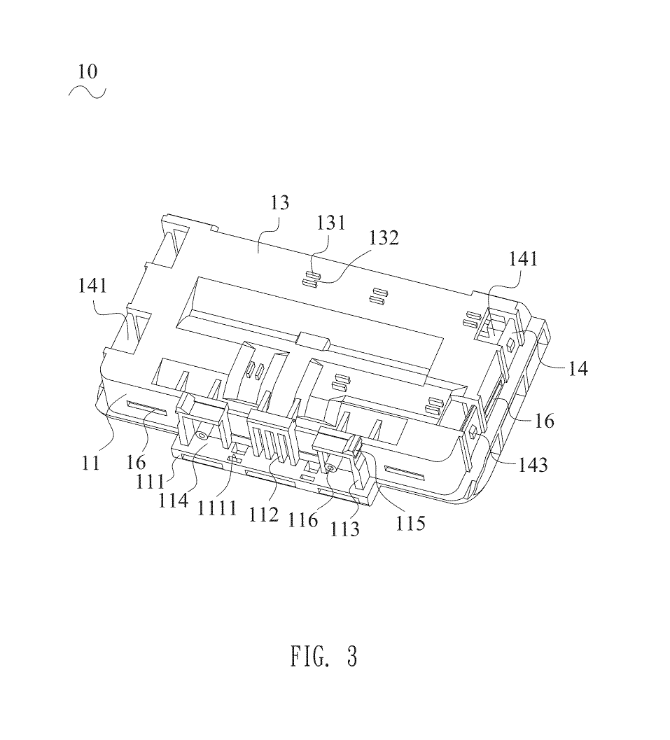

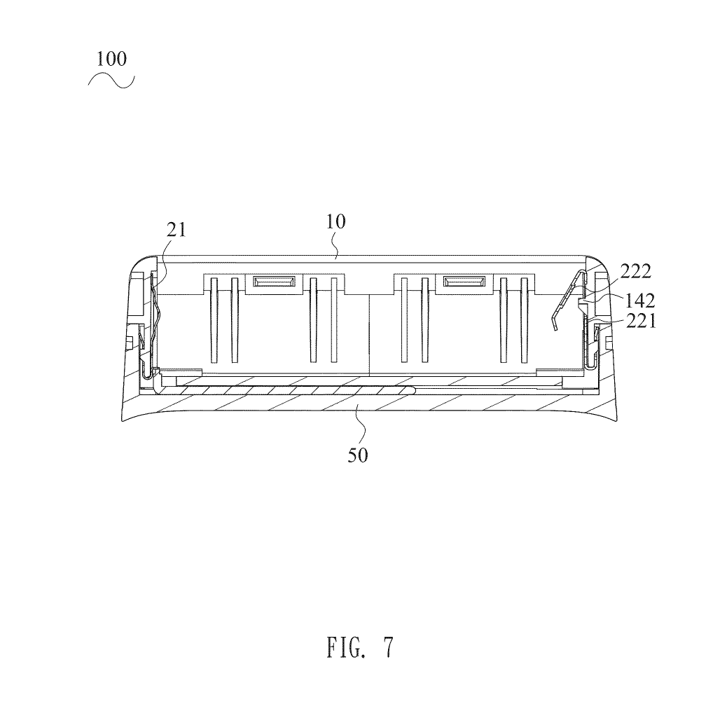

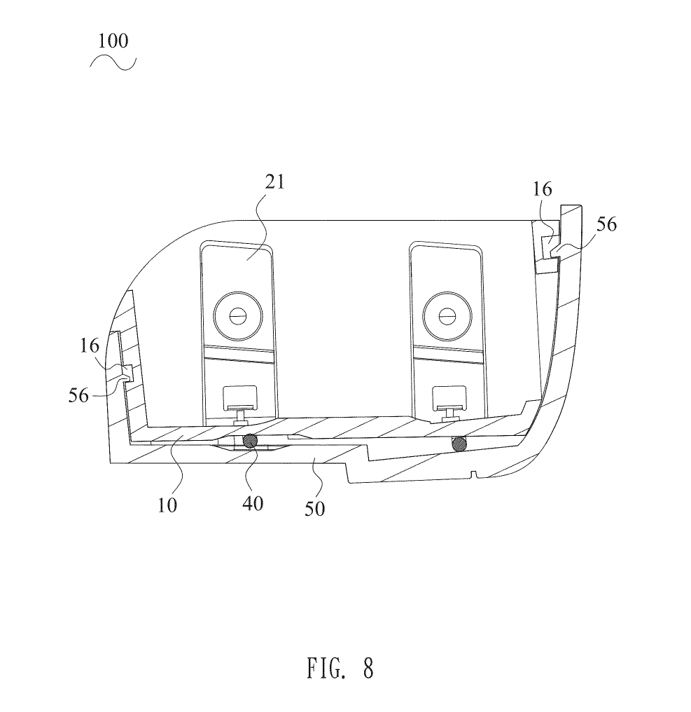

Referring to FIG. 2, FIG. 3, FIG. 7 and FIG. 8, the upper half housing 10 has a front wall 11, a rear wall 12, a bottom wall 13 and two side walls 14 which together form a receiving cavity 15 for receiving the battery. Two sides of a front face of the front wall 11 protrude forward and then bend inward to form a pair of L-shaped positioning supports 113. The positioning supports 113 are vis-a-vis each other to define a receiving area 114 therebetween, wherein the PCB 30 is positioned in the receiving area 114. A center of a top edge of the front wall 11 protrudes frontward to form a restricting plate 111 located over the positioning supports 113 to restrict the PCB 30 in the receiving area 114. Two sides of a bottom face of the restricting plate 111 are concaved upward to form a pair of positioning slots 1111. A center of the bottom face of the restricting plate 111 protrudes downward to form a resisting portion 112. Two outer corners of the positioning supports 113 protrude downward to form a pair of upper hooks 115. The front face of the front wall 11 further protrudes frontward to form a pair of positioning columns 116 located in the receiving area 114 and at two sides of the resisting portion 112.

The bottom face of the bottom wall 13 protrudes downward to form at least one pair of clamping lumps 131 which are in parallel with each other. A clamping slot 132 is formed between the pair of clamping lumps 131 for clamping the guide lines 40 therein. Two inner sides of the side walls 14 are concaved inward and then penetrate vertically through the bottom wall 13 to form a plurality of installing grooves 141. Two opposite outer sides of the upper half housing 10 protrude outward to form a plurality of buckling lumps 143 arranged in accordance with the installing grooves 141 respectively. The front wall 11, the rear wall 12 and the side walls 14 of the upper half housing 10 define a plurality of buckling slots 16.

Referring to FIG. 2 and FIG. 7, the elastic slices 20 are inserted upward in the installing grooves 141 of the side walls 14 of the upper half housing 10. In detail, the elastic slices 20 include a plurality of first elastic slices 21 and a plurality of second elastic slices 22. Each of the first elastic slices 21 has a U-shaped first fastening portion 211. An inner arm of the first fastening portion 211 protrudes upward to form a first contact portion 212. An outer arm of the first fastening portion 211 is opened with a first fastening hole 213 corresponding to the buckling lumps 143 of one side wall 14 respectively. Each of the second elastic slices 22 has a U-shaped second fastening portion 221. An inner arm of the second fastening portion 221 protrudes upward and then bends slantwise downward to form a second contact portion 222. An outer arm of the second fastening portion 211 is opened with a second fastening hole 223 corresponding to the buckling lumps 143 of the other side wall 14 respectively. The installing grooves 141 of the other side wall 14 respectively define a blocking lump 142 therein. The part of the second contact portion 222 connecting with the inner arm of the second fastening portion 221 is opened with a blocking hole 224 corresponding to the blocking lump 142 of the upper half housing 10.

The PCB 30 is positioned in the receiving area 114 of the front wall 11 of the upper half housing 10, and the elastic slices 20 are exposed in the receiving cavity 15 to electrically contact with the battery. In detail, two sides of the PCB 30 are opened with a pair of positioning holes 31 corresponding to the positioning columns 116 of the upper half housing 10. The PCB 30 has a plurality of touch points 32 in a front face thereof.

The guide lines 40 are mounted to a bottom face of the bottom wall 13 of the upper half housing 10.

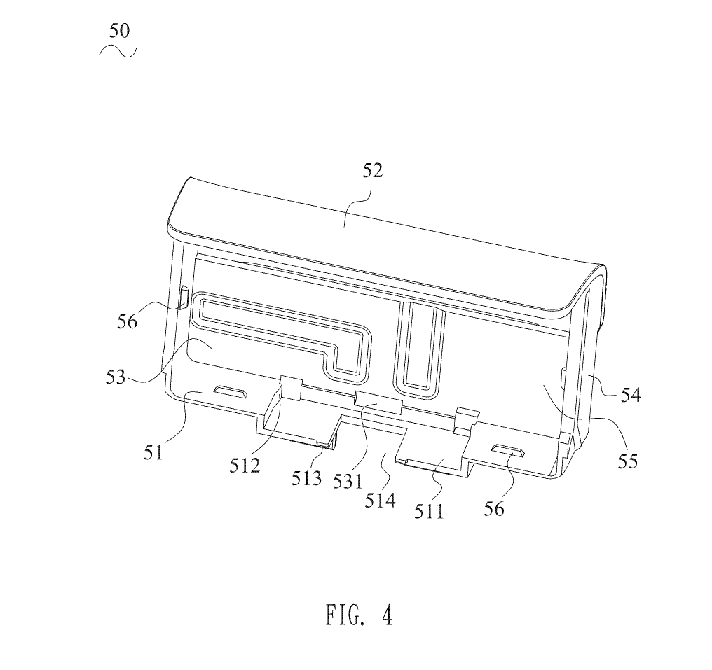

Referring to FIG. 2 and FIG. 4, the lower half housing 50 has a front plate 51, a rear plate 52, a bottom plate 53 and two side plates 54 which together form a receiving chamber 55. A rear face of a center of the front plate 51 is concaved frontward to form a holding groove 511. Two sidewalls of the holding groove 511 protrude inward to form a pair of lower hooks 512 corresponding to the upper hooks 115 of the upper half housing 10. A top edge of the front plate 51 of the lower half housing 50 protrudes upward to form a pair of positioning lugs 513 corresponding to the positioning slots 1111 of the upper half housing 10. A center of the front plate 51 is opened with a gap 514 corresponding to the touch points 32 of the PCB 30 to expose the touch points 32 out of the front plate 51 of the lower half housing 50. An inner side of the rear plate 52 protrudes frontward and upward to from a plurality of locking strips 521. A plurality of locking slots 522 is defined between the rear plate 52 and top ends of the locking strips 521. A center of a front of the bottom plate 53 defines a fastening slot 531 corresponding to the resisting portion 112 of the upper half housing 10 Inner faces of the front plate 51, the rear plate 52 and the side plates 54 protrude inward to form a plurality of wedge-shaped lumps 56 corresponding to the buckling slots 16 of the upper half housing 10.

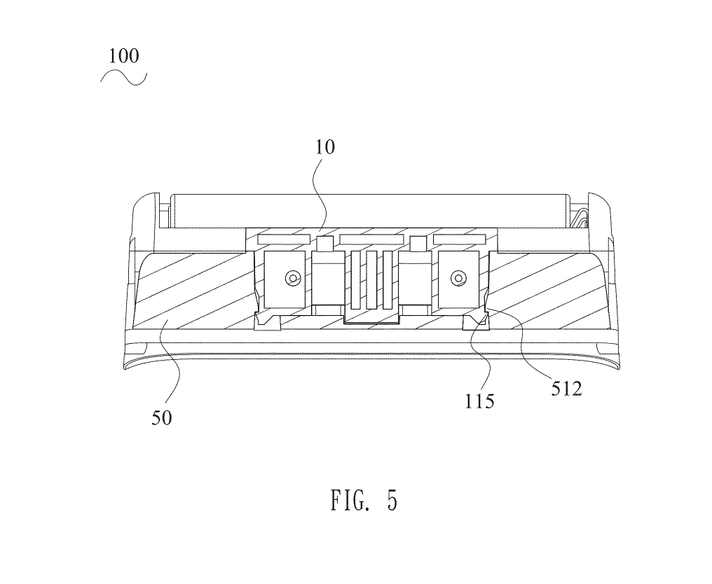

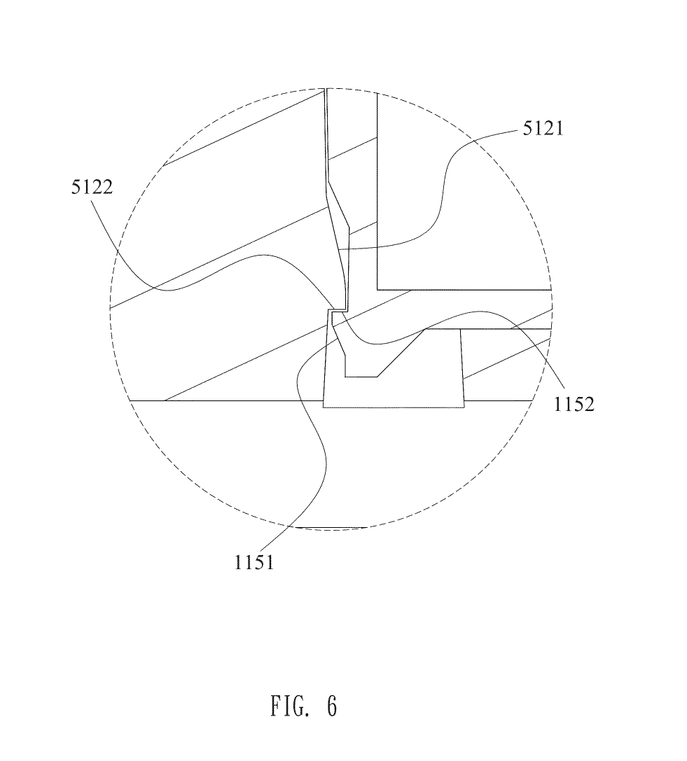

Referring to FIGS. 1-8, in assembly, the inner arm of the first fastening portion 211 and the first contact portion 212 are fastened in one installing groove 141 of the one side wall 14. The buckling lumps 143 of the one side wall 14 are respectively buckled in the first fastening hole 213 of the first fastening portion 211. The inner arm of the second fastening portion 221 and a part of the second contact portion 222 are fastened in one installing groove 141 of the other side wall 14. The buckling lumps 143 of the other side wall 14 are respectively buckled in the second fastening hole 223 of the second fastening portion 221. A free arm of the second contact portion 222 elastically projects in the receiving cavity 15 of the upper half housing 10. The blocking lump 142 of the other side wall 14 is buckled in the blocking hole 224 of the second contact portion 221. In the embodiment of the present invention of the battery holder 100, the blocking lump 142 is located between the other side wall 14 and the free arm of the second contact portion 222 of the second elastic slice 22 to prevent the free arm of the second contact portion 222 from permanent deformation by external force.

The resisting portion 112 of the upper half housing 10 resists against a back face of the PCB 30. The positioning columns 116 are positioned in the positioning holes 31 of the PCB 30. The elastic slices 20 are electrically connected with the PCB 30 through the guide lines 40. In detail, the guide lines 40 are clamped in the clamping slots 132.

The upper half housing 10 is placed in the receiving chamber 55 of the lower half housing 50. The positioning supports 113 together with the PCB 30 are received in the holding groove 511 of the front plate 51 of the lower half housing 50. The bottom end of the resisting portion 112 of the upper half housing 10 is buckled in the fastening slot 531 of the bottom plate 53 of the lower half housing 50. The upper hook 115 of the upper half housing 10 and the lower hook 512 of the lower half housing 50 are hooked together. A bottom end of the rear wall 12 of the upper half housing 10 is buckled in the locking slots 522 of the rear plate 52 of the lower half housing 50. The positioning lugs 513 of the front plate 51 of the lower half housing 50 are buckled in the positioning slots 1111 of the restricting plate 111 of the upper half housing 10. The wedge-shaped lumps 56 of the lower half housing 50 are respectively buckled in the buckling slots 16 of the upper half housing 10.

In the embodiment of the present invention of the battery holder 100, a bottom of the upper hook 115 is designed as a first slant surface 1151. A top of the lower hook 512 is designed as a second slant surface 5121 cooperating with the first slant surface 1151 of the upper hook 115 in the process of the upper half housing 10 being placed in the lower half housing 50. A top of the upper hook 115 is designed as a horizontal first blocking surface 1152. A bottom of the lower hook 512 is designed as a horizontal second blocking surface blocking 5122 against each other when the upper half housing 10 is in the lower half housing 50.

As described above, the front wall 11, the rear wall 12 and the side walls 14 of the upper half housing 10 define the buckling slots 16. The inner faces of the front plate 51, the rear plate 52 and the side plates 54 protrude inward to form the wedge-shaped lumps 56 corresponding to the buckling slots 16 of the upper half housing 10. The wedge-shaped lumps 56 of the lower half housing 50 are respectively buckled in the buckling slots 16 of the upper half housing 10 so that is convenient for assembly of the battery holder 100 and reduces cost of the battery holder 100. The center of the bottom face of the restricting plate 111 protrudes downward to form the resisting portion 112 resisting against the back face of the PCB 30 so that can prevent the PCB 30 from permanent deformation by external force. The installing grooves 141 of the other side wall 14 respectively define the blocking lump 142 therein which is located between the other side wall 14 and the free arm of the second contact portion 222 of the second elastic slice 22 so as to prevent the second elastic slice 22 from permanent deformation by external force.

What is claimed is:

1. A battery holder for receiving a battery therein, comprising:
an upper half housing having a front wall, a rear wall, a bottom wall and two side walls which together form a receiving cavity for receiving the battery, two sides of a front face of the front wall protruding forward and then bending inward to form a pair of L-shaped positioning supports, the positioning supports being vis-a-vis each other to define a receiving area therebetween, two outer corners of the positioning supports protruding downward to form a pair of upper hooks, two inner sides of the side walls being concaved inward and then penetrating vertically through the bottom wall to form a plurality of installing grooves, the front wall, the rear wall and the side walls of the upper half housing defining a plurality of buckling slots;
a plurality of elastic slices inserted upward in the installing grooves of the side walls of the upper half housing, the elastic slices being exposed in the receiving cavity to electrically contact with the battery;
a PCB positioned in the receiving area of the upper half housing;
a plurality of guide lines mounted to a bottom face of the bottom wall of the upper half housing, the elastic slices being electrically connected with the PCB through the guide lines; and
a lower half housing having a front plate, a rear plate, a bottom plate and two side plates which together form a receiving chamber, a rear face of a center of the front plate being concaved frontward to form a holding groove, two sidewalls of the holding groove protruding inward to form a pair of lower hooks corresponding to the upper hooks of the upper half housing, an inner side of the rear plate protruding frontward and upward to from a plurality of locking strips, a plurality of locking slots being defined between the rear plate and top ends of the locking strips, inner faces of the front plate, the rear plate and the side plates protruding inward to form a plurality of wedge-shaped lumps corresponding to the buckling slots of the upper half housing, wherein the upper half housing is placed in the receiving chamber of the lower half housing, the positioning supports together with the PCB are received in the holding groove of the front plate of the lower half housing, the upper hooks of the upper half housing and the lower hooks of the lower half housing are hooked together, a bottom end of the rear wall of the upper half housing is buckled in the locking slots of the rear plate of the lower half housing, the wedge-shaped lumps of the lower half housing are respectively buckled in the buckling slots of the upper half housing.

2. The battery holder as claimed in claim 1, wherein two opposite outer sides of the upper half housing protrude outward to form a plurality of buckling lumps arranged in accordance with the installing grooves respectively, the elastic slices include a plurality of first elastic slices and a plurality of second elastic slices, each of the first elastic slices has a U-shaped first fastening portion, an inner arm of the first fastening portion protrudes upward to form a first contact portion, an outer arm of the first fastening portion is opened with a first fastening hole corresponding to the buckling lumps of one side wall respectively, the inner arm of the first fastening portion and the first contact portion are fastened in one installing groove of the one side wall, the buckling lumps of the one side wall are respectively buckled in the first fastening hole of the first fastening portion, each of the second elastic slices has a U-shaped second fastening portion, an inner arm of the second fastening portion protrudes upward and then bends slantwise downward to form a second contact portion, an outer arm of the second fastening portion is opened with a second fastening hole corresponding to the buckling lumps of the other side wall respectively, the inner arm of the second fastening portion and a part of the second contact portion are fastened in one installing groove of the other side wall, the buckling lumps of the other side wall are respectively buckled in the second fastening hole of the second fastening portion, a free arm of the second contact portion elastically projects in the receiving cavity.

3. The battery holder as claimed in claim 2, wherein the installing grooves of the other side wall respectively define a blocking lump therein, the part of the second contact portion connecting with the inner arm of the second fastening portion is opened with a blocking hole corresponding to the blocking lump of the upper half housing, the blocking lump of the other side wall is buckled in the blocking hole of the second contact portion.

4. The battery holder as claimed in claim 1, wherein a center of a top edge of the front wall protrudes frontward to form a restricting plate located over the positioning supports to restrict the PCB in the receiving area, a center of a bottom face of the restricting plate of the front wall protrudes downward to form a resisting portion, the front face of the front wall further protrudes frontward to form a pair of positioning columns located in the receiving area and at two sides of the resisting portion, two sides of the PCB are opened with a pair of positioning holes corresponding to the positioning columns of the upper half housing, the resisting portion of the upper half housing resists against a back face of the PCB, the positioning columns are positioned in the positioning holes of the PCB.

5. The battery holder as claimed in claim 4, wherein two sides of a bottom face of the restricting plate are concaved upward to form a pair of positioning slots, a top edge of the front plate of the lower half housing protrudes upward to form a pair of positioning lugs corresponding to the positioning slots of the upper half housing, the positioning lugs of the front plate of the lower half housing are buckled in the positioning slots of the restricting plate of the upper half housing, a center of a front of the bottom plate defines a fastening slot corresponding to the resisting portion of the front wall of the upper half housing, a bottom end of the resisting portion of the upper half housing is buckled in the fastening slot of the bottom plate of the lower half housing.

6. The battery holder as claimed in claim 1, wherein the PCB has a plurality of touch points in a front face thereof, a center of the front plate is opened with a gap corresponding to the touch points of the PCB to expose the touch points out of the front plate of the lower half housing.

7. The battery holder as claimed in claim 1, wherein the bottom face of the bottom wall protrudes downward to form at least one pair of clamping lumps which are in parallel with each other, a clamping slot is formed between the pair of clamping lumps for clamping the guide lines therein.

8. The battery holder as claimed in claim 1, wherein a bottom of the upper hook is designed as a first slant surface, a top of the lower hook is designed as a second slant surface cooperating with the first slant surface of the upper hook in the process of the upper half housing being placed in the lower half housing, a top of the upper hook is designed as a horizontal first blocking surface, a bottom of the lower hook is designed as a horizontal second blocking surface blocking against each other when the upper half housing is in the lower half housing.
